(19) United States
(12) Patent Application Publication
(10) Pub. No.: US 2026/0149895 A1
(43) Pub. Date: May 28, 2026

(54) OUT-OF-LINE PIXEL DETECTION

(71) Applicant: TRINAMIX GMBH, Ludwigshafen am Rhein (DE)

(72) Inventors: Stefan HOOS, Ludwigshafen am Rhein (DE); Andre HORSAK, Ludwigshafen am Rhein (DE); Michael HANKE, Ludwigshafen am Rhein (DE); Felix SCHMIDT, Ludwigshafen am Rhein (DE)

(21) Appl. No.: 19/127,242

(22) PCT Filed: Nov. 15, 2023
(86) PCT No.: PCT/EP23/81858

§ 371 Date: May 5, 2025

(30) Foreign Application Priority Data
Nov. 16, 2022 (EP) 22207731.5

(51) Int. Cl. H04N 25/683; G01J 3/02; G01J 3/28

(52) U.S. Cl. CPC H04N 25/683; G01J 3/027; G01J 3/2803

(57) ABSTRACT

Disclosed herein are a method for automated quality control of at least one photodetector, a photodetector for measuring optical radiation and a spectrometer for spectrally analyzing optical radiation provided by at least one object.

Further disclosed herein are a computer program and a computer-readable storage medium for performing the method.

### TECHNICAL FIELD

The invention relates to a method for automated quality control of at least one photodetector, a photodetector and a spectrometer. Such methods and devices can, in general, be used for investigation or monitoring purposes, in particular in the infrared (IR) spectral region, especially in the near-infrared (NIR) spectral region, as well as for a detection of heat, flames, fire, or smoke. However, further kinds of applications are possible.

### BACKGROUND ART

Adjacent pixels of NIR spectrometers may be conspicuous. For example, neighboring pixels may provide implausible signals e.g. due to unwanted, electrical or optical connections or an instability of electrical or optical properties of the respective pixels over time or ambient conditions such as temperature. This may affect a detector with more than one pixel, which shows a nonresolvable spectral trend or strong deviation from the samples' response in a reproducible way. These pixels can be identified by measuring a spectrum with sufficient dynamics in the range of the affected pixels.

Pixels, which do not follow the samples' response, simultaneously the spectral data is not under sampled by the resolution of the spectrometers' dispersive element, and there is no reproducibility given due to high noise (low signal to noise ratio), represent the out-of-line pixels. Out-of-line pixels do not contain spectral information necessary for chemo metrical modelling. Therefore, a sensor array module with identified out-of-line pixels may be unsuitable for a spectrometer and needs to be marked as bad or replaced.

Usually, the out-of-line pixel are searched manually in a plot of a spectrum which is time consuming.

US 2012/323533 A1 describes cosmic spike filters, which remove noise spikes in spectral data. Spikes are eliminated by locating, smoothing and filtering the spikes. Cosmic spike filters are also provided that combine a data collection approach and a statistical approach to remove cosmic spike noise from the collected signal without distorting the true signal. Still further, a statistical approach is provided to identify and remove negative peaks from a spectrum, where the negative peaks are caused by bad pixels in a charge coupled device.

US 2014/268136 A1 describes a method and an spectrometer system for correcting for light source quality, exposure time, distortion in y direction, distortion in x direction, temperature dependence, pixel alignment variability, dark pixels, bad pixels, pixel read noise, and pixel dark current noise.

### Problem to be Solved

It is therefore desirable to provide methods and devices, which at least partially address abovementioned technical challenges. Specifically, a method and a device for automated quality control of pixels for spectrometers shall be proposed which allow to save time and which ensure high reliability.

### SUMMARY

This problem is addressed by a method for automated quality control of at least one photodetector, a photodetector, a spectrometer, by a computer program and a computer-readable storage medium with the features of the independent claims. Advantageous embodiments which might be realized in an isolated fashion or in any arbitrary combinations are listed in the dependent claims as well as throughout the specification.

In a first aspect of the present invention, a method for automated quality control of at least one photodetector comprising a plurality of pixels i, with i being a pixel position and i>2 is disclosed. Each pixel comprises at least one photosensitive region. Each of the pixels is configured for generating a signal in response to illumination by optical radiation of its respective photosensitive region.

The term “photodetector” as used herein is a broad term and is to be given its ordinary and customary meaning to a person of ordinary skill in the art and is not to be limited to a special or customized meaning. The term specifically may refer, without limitation, to an optical detector or optical sensor configured for detecting optical radiation, such as for detecting an illumination and/or a light spot generated by at least one light beam.

The term “photosensitive region” as used herein is a broad term and is to be given its ordinary and customary meaning to a person of ordinary skill in the art and is not to be limited to a special or customized meaning. The term specifically may refer, without limitation, to a unit of a photodetector configured for being illuminated, or in other words for receiving optical radiation, and for generating at least one signal, such as an electronic signal, in response to the illumination. The photosensitive region may be located on a surface of the photodetector. The photosensitive region may specifically be a single, closed, uniform photosensitive region. However, other options may also be feasible. The photosensitive region may also be referred to as pixel. The photodetector comprises a plurality of pixels, which may be arranged in at least one of an array or a matrix. The pixels may be arranged in a 2D distribution. The pixels may be arranged in a pattern. The pattern may be periodical or non-periodical. The pattern may be a rectangular, a hexagonal or otherwise shaped pattern. The pixel may comprise at least one substrate. A single pixel may be a substrate with at least one single photosensitive region, which generates a physical response to the illumination for a given wavelength range. However, other options may also be feasible.

The illumination may be provided by at least one measurement object. The providing may comprise at least one of a reflecting, transmitting and emitting. Specifically, before interacting with the measurement object, the illumination may e.g. be emitted by at least one radiation source, in particular of a spectrometer comprising the photodetector or a further radiation source. The term “radiation source” as used herein is a broad term and is to be given its ordinary and customary meaning to a person of ordinary skill in the art and is not to be limited to a special or customized meaning. The term specifically may refer, without limitation, to a device configured for emitting optical radiation. The radiation source may be configured for emitting optical radiation towards the measurement object, such as in form of a light beam. The radiation source may be configured for isotopically emitting optical radiation, e.g. uniformly in all spatial directions, wherein only a part of the emitted optical radiation may impinge the measurement object. The radiation source may comprise at least one of a semiconductor-based radiation source or a thermal radiator. The at least one semiconductor-based radiation source may be selected from at least one of a light emitting diode (LED) or a laser, specifically a laser diode. The LED may comprise at least one fluorescent and/or phosphorescent material. The thermal radiator may comprise at least one of an incandescent lamp, a black body emitter and a microelectromechanical system (MEMS) emitter. The radiation source may be a modulated radiation source. Further kinds of radiation sources may also be feasible.

The term “light” as used herein is a broad term and is to be given its ordinary and customary meaning to a person of ordinary skill in the art and is not to be limited to a special or customized meaning. The term specifically may refer, without limitation, to a partition of electromagnetic radiation which is, usually, referred to as “optical spectral range” and which comprises one or more of a visible spectral range, an ultraviolet spectral range and an infrared spectral range. The terms “ultraviolet spectral” or “UV”, generally, refer to electromagnetic radiation having a wavelength of 1 nm to 380 nm, preferably of 100 nm to 380 nm. The term “visible”, generally, refers to a wavelength of 380 nm to 760 nm. The terms “infrared” or “IR”, generally, refer to a wavelength of 760 nm to 1000 μm, wherein a wavelength of 760 nm to 3 μm is, usually, denominated as “near infrared” or “NIR” while the wavelength of 3μ to 15 μm is, usually, denoted as “mid infrared” or “MidIR” and the wavelength of 15 μm to 1000 μm as “far infrared” or “FIR”.

Preferably, the illumination which is used for typical purposes of the present invention is IR radiation, more preferred, NIR radiation, especially of a wavelength of 760 nm to 3 μm, preferably of 1 μm to 3 μm. The illumination may specifically be optical radiation impinging the photodetector, or more specifically the photosensitive regions. The term “illumination” may also be referred to as “optical radiation” or as “light” herein. The photodetector may be configured for detecting optical radiation in a wavelength of 300 nm to 3000 nm, specifically 500 nm to 2500 nm, more specifically 1400 nm to 2000 nm. The pixels of the photodetector may be responsive to incident illumination and may be configured for generating an electrical signal indicating an intensity of the illumination. The photodetector may be sensitive in one or more of a visible spectral range, an ultraviolet spectral range or the infrared spectral range, specifically a near infrared spectral range (NIR). The photodetector may be sensitive for electromagnetic radiation in wavelength range from 600 nm to 1000 μm, specifically in a wavelength range from 760 nm to 15 μm, more specifically in a wavelength range from 1 μm to 5 μm, more specifically in a wavelength range from 1 μm to 3 μm.

A spectrum may be a partition of the optical spectral range, in particular, the IR spectral range, especially at least one of the NIR or the MidIR spectral ranges, being investigated by the spectrometer device. Each part of the spectrum may be constituted by an optical signal which is defined by a signal wavelength and the corresponding signal intensity. The term “constituent wavelength component” as used herein is a broad term and is to be given its ordinary and customary meaning to a person of ordinary skill in the art and is not to be limited to a special or customized meaning. The term specifically may refer, without limitation, to the optical signal forming part of the spectrum. Specifically, the optical signal may comprise the signal intensity corresponding to the respective wavelength or wavelength interval. The pixels of the photodetector may be configured for receiving at least a portion of one of the constituent wavelength components and for generating a respective signal depending on an illumination of the respective pixel by the at least one portion of the respective constituent wavelength component.

The illumination may be modulated, e.g. by using at least one modulated radiation source. The radiation source may be the modulated radiation source. The term “modulating” including any grammatical variation thereof as used herein is a broad term and is to be given its ordinary and customary meaning to a person of ordinary skill in the art and is not to be limited to a special or customized meaning. The term specifically may refer, without limitation, to a process of changing, specifically periodically changing, at least one property of optical radiation, specifically one or both of an intensity or a phase of the optical radiation. As the skilled person will know, the intensity again relates to an amplitude of the optical radiation. The modulation may be a full modulation from a maximum value to zero, or may be a partial modulation, from a maximum value to an intermediate value greater than zero. The modulating may comprise using a modulating element. The modulating element may be configured for e.g. mechanically modulating the optical radiation, e.g. by using a rotating chopper wheel, and/or for electronically modulating the optical radiation, e.g. by using an electrooptic effect and/or an acoustoptic effect, e.g. by using a Pockels cell and/or a Kerr cell. Further options are feasible.

The photosensitive region may comprise at least one photoconductive material. The photoconductive material may be selected from at least one of PbS, PbSe, Ge, InGaAs, InSb, or HgCdTe. Other options, such as photodiodes or thermopiles, may also be feasible. The photodetector may be configured for generating at least one signal, specifically in response to an illumination of the photosensitive region, such as a photocurrent. The photodetector specifically may be or may comprise an optical semiconductor sensor. As an example, specifically in case the photodetector is sensitive in the infrared spectral range, such as in the near infrared spectral range, the optical semiconductor sensor may be or may comprise at least one semiconductor sensor comprising at least one material selected from the group consisting of Si, PbS, PbSe, Ge, InGaAs, extended-InGaAs, InSb or HgCdTe. For example, the photodetector may be or may comprise at least one line sensor comprising a one-dimensional array of pixels, e.g. a CCD line sensor, a CMOS line sensor and the like. For example, the photodetector may be or may comprise a two-dimensional array of pixels, e.g. a CCD sensor, a CMOS sensor and the like.

The photodetector specifically may comprise at least one detector array comprising a plurality of pixelated sensors, wherein each of the pixelated sensors is configured to detect at least a portion of at least one constituent wavelength component. The photodetector may comprise the plurality of pixels arranged in a linear array. The linear array of photosensitive elements may comprise a number of 10 to 1000 pixels, specifically a number of 100 to 500 pixels, specifically a number of 200 to 300 pixels, more specifically a number of 256 pixels. Other numbers of pixels, however, may be feasible. The term “pixel position” as used herein is a broad term and is to be given its ordinary and customary meaning to a person of ordinary skill in the art and is not to be limited to a special or customized meaning. The term specifically may refer, without limitation, to a position of the respective pixel in the array.

The photodetector may further comprise at least one readout electronics unit. The term “readout” as used herein is a broad term and is to be given its ordinary and customary meaning to a person of ordinary skill in the art and is not to be limited to a special or customized meaning. The term specifically may refer, without limitation, to an action or process of quantifying and/or processing at least one physical property and/or a change in at least one physical property detected by at least one device, specifically by the at least one photodetector or more specifically the photosensitive region. The readout may comprise an individual readout of one device such as of one photosensitive region. Additionally or alternatively, the readout may comprise a readout of a group of devices such as a group of photosensitive regions.

The term “readout electronics unit” as used herein is a broad term and is to be given its ordinary and customary meaning to a person of ordinary skill in the art and is not to be limited to a special or customized meaning. The term specifically may refer, without limitation, to an electronics unit configured for quantifying and/or processing at least one physical property and/or a change in at least one physical property detected by the photodetector or more specifically the photosensitive region. The readout electronics unit may comprise at least one of: an operational amplifier; an analog-to-digital converter; a voltage divider; a current divider, an ASIC, specifically for subtracting a constant current for generating a signal current.

The photodetector may be an element of a spectrometer for spectrally analyzing optical radiation provided by at least one measurement object. The term “spectrometer” as used herein is a broad term and is to be given its ordinary and customary meaning to a person of ordinary skill in the art and is not to be limited to a special or customized meaning. The term specifically may refer, without limitation, to a device capable of optically analyzing at least one sample, thereby generating at least one item of information on at least one spectral property of the sample. Specifically, the term may refer to a device which is capable of recording a signal intensity with respect to a corresponding wavelength of a spectrum or a partition thereof, such as a wavelength interval, wherein the signal intensity may, preferably, be provided as an electrical signal which may be used for further evaluation. An optical element, specifically comprising at least one wavelength-selective element, such as an optical filter and/or a dispersive element, may be used for separating incident light into a spectrum of constituent wavelength components whose respective intensities are determined by employing a detector device. In addition, a further optical element may be used which can be designed for receiving incident light and transferring the incident light to the optical element. The spectrometer, generally, may be operable in a reflective mode and/or may be operable in a transmissive mode. For possible embodiment of the spectrometer, reference is made to the description of the spectrometer as will be outlined in further detail below.

The term “signal” as used herein is a broad term and is to be given its ordinary and customary meaning to a person of ordinary skill in the art and is not to be limited to a special or customized meaning. The term specifically may refer, without limitation, to a signal generated by the photodetector, specifically to the at least one output signal of the pixel. The at least one output signal may be selected from at least one of an electronic signal and an optical signal. The at least one output signal may be an analogue signal and/or a digital signal. The output signals for adjacent pixels can be generated simultaneously, or in a temporally successive manner. By way of example, during a row scan or a line scan, it can be feasible to generate a sequence of output signals which correspond to the series of the photosensitive elements which may be arranged in a line. In addition, the individual pixels may, preferably, be active pixel sensors which may be adapted to amplify the output signals prior to providing them as detector signals to an external processor. For this purpose, the pixels may comprise one or more signal processing devices, such as one or more filters and/or analogue-digital-converters for processing and/or preprocessing the electronic signals.

The term “quality” as used herein is a broad term and is to be given its ordinary and customary meaning to a person of ordinary skill in the art and is not to be limited to a special or customized meaning. The term specifically may refer, without limitation, to a measure for plausibility of a signal generated by a pixel of the photodetector. Neighboring pixels of the photodetector may provide implausible signals e.g., due to unwanted, electrically or optical connections, which may result in a non-resolvable spectral trend or deviation from the samples' response in a reproducible way. For example, two or more pixels may be short-circuited. Said pixels showing implausible signals are denoted as out-of-line pixels. As used herein, the term “out-of-line pixel” is a broad term and is to be given its ordinary and customary meaning to a person of ordinary skill in the art and is not to be limited to a special or customized meaning. The term specifically may refer, without limitation, to a pixel showing implausible signal behavior. For example, the out-of-line pixel may have a systematic deviation in signal behavior from the signal behavior of the other pixels of the photodetector or of one or more other regions of the photodetector, e.g. a deviation in signal behavior from the signal behavior of the other pixels of the array or matrix of pixels or of one or more other regions of the array or matrix.

As used herein, the term “quality control” is a broad term and is to be given its ordinary and customary meaning to a person of ordinary skill in the art and is not to be limited to a special or customized meaning. The term specifically may refer, without limitation, to at least one process of determining if out-of-line pixels are present. The quality control may comprise classifying the pixels of the photodetector into reliable and out-of-line pixels. Results of the quality control may be stored in at least one Log-file. The quality control may comprise masking all pixels which are classified as out-of-line. The quality control may comprise issuing at least one indication about the presence of out-of-line pixels, e.g. by using at least one user interface. The term “user interface” as used herein is a broad term and is to be given its ordinary and customary meaning to a person of ordinary skill in the art and is not to be limited to a special or customized meaning. The term may refer, without limitation, to a feature of the spectrometer configured for interacting with its environment, such as for the purpose of unidirectionally or bidirectionally exchanging information, such as for exchange of one or more of data or commands. For example, the user interface may be configured to share information with a user and to receive information by the user. The user interface of may be a feature to interact visually with a user, such as a display, or a feature to interact acoustically with the user. The user interface, as an example, may comprise one or more of: a graphical user interface; a data interface, such as a wireless and/or a wire-bound data interface. The quality control may comprise replacing the pixels classified as out-of-line pixels.

The term “automated” as used herein is a broad term and is to be given its ordinary and customary meaning to a person of ordinary skill in the art and is not to be limited to a special or customized meaning. The term specifically may refer, without limitation, to a process which is performed completely by means of at least one computer and/or computer network and/or machine, in particular without manual action and/or interaction with a user. The method may be at least partially computer-implemented. The term “computer implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present invention. Specifically, each of the method steps is performed by the computer and/or computer network. The method may be performed completely automatically, specifically without user interaction.

The method comprises classifying of out-of-line pixels by
a) measuring a plurality of signals Sᵢ for the pixels by measuring at least one object using the photodetector;
b) by using at least one processor, comparing the measured signals Sᵢ and at least one reference spectrum S_{F,i}, determining at least one quantifier Cᵢ for each pixel i quantifying a deviation between the respective measured signal Sᵢ and the reference spectrum S_{F,i}, and comparing the respective quantifier Cᵢ to at least one threshold Cₘₐₓ, wherein a pixel is classified as out-of-line pixel in case the respective quantifier Cᵢ exceeds the limit Cₘₐₓ.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion. The method may comprise repeating steps a) and b) at pre-defined times or continuously.

The signal Sᵢ may be a signal generated by the pixel i in response to illumination. The method may comprise measuring a plurality of signals Sᵢ for each of the pixels i, e.g. by repeatedly measuring the object with the photodetector. For example, the method may comprise measuring two, three, four, five, up to ten or even more measurements for each pixel i.

The method may comprise determining a plurality of measured spectra by using the signals of the pixels as a function of the pixels i. For example the measured spectrum may be determined by, in case of a modulated radiation source, recording a plurality of imaging frames, e.g. 1000 imaging frames. A plurality of signals (depending on the modulation frequency) of the photodetector may be measured with and without illumination. These signals may be evaluated, e.g. by using one or more of at least one FFT or DFT. The evaluation may further comprise using a standard white measurement thereby determining a measured spectrum. For example, the measured spectrum may be determined by determining a mean value of the signals of the pixels over time. The method may comprise, e.g. during step a) and/or by repeating step a), determining a plurality of spectra. These measured spectra may be used for classifying whether the deviation (outlier) of the pixel under suspect results due to SNR or is systematically present and, thus, has to be classified as out-of-line pixel.

The term “spectrum” as used herein is a broad term and is to be given its ordinary and customary meaning to a person of ordinary skill in the art and is not to be limited to a special or customized meaning. The term specifically may refer, without limitation, to a partition of the optical radiation, wherein the spectrum is constituted by an optical signal defined by a signal wavelength and a corresponding signal intensity. In particular, the spectrum may comprise spectral information related to at least one object, such as a type and composition of at least one material forming the object, which can be determined by recording at least one spectrum related to the object. The spectrum may be presented in a diagram, in which e.g. a spectral quantity as a function of the pixel position is plotted.

The term “object”, also denoted as measurement object, as used herein is a broad term and is to be given its ordinary and customary meaning to a person of ordinary skill in the art and is not to be limited to a special or customized meaning. The term specifically may refer, without limitation, to an arbitrary body, chosen from a living body and a non-living body. The measurement object may specifically comprise at least one material which is subject to an investigation. The object may generally refer to an object which is to be measured, e.g. for which a spectrum is to be recorded, wherein the object may have in principle arbitrary properties, e.g. arbitrary optical properties or an arbitrary shape. The object may comprise at least one solid sample. However, other measurement objects such as fluids may also be feasible.

The classifying of out-of-line pixels may be performed using an arbitrary rising or falling part of the spectrum having a sufficient high slope, wherein only pixels lying on said slope are used. The term “sufficiently high” may refer to a slope which leads to a signal difference between neighboring pixels, which is higher than the noise-induced fluctuation of the signal at these pixels. Noise may originate from fluctuations of light source, detector, and other elements. The slope-induced signal difference between neighboring pixels may be at least 2 times above the noise limit, preferably 4 or even 6 times above. Otherwise, noise may induce false detection of out-of-line pixels due to statistical fluctuations.

The object may comprise at least one material having a plurality of dynamic spectral areas. The term “dynamic spectral area” as used herein is a broad term and is to be given its ordinary and customary meaning to a person of ordinary skill in the art and is not to be limited to a special or customized meaning. The term specifically may refer, without limitation, to spectrum with high contrast, e.g. ideally covering an entire dynamic range of the optical system. For example, relative to a maximum possible signal level of the optical system, the spectrum may cover a range from 50% to 90%, preferably from 10% to 90%, more preferably from 1% to 90%. The contrast changes may be at a length scale (pixel to pixel) similar to the optical resolution of the optical system.

The dynamic spectral areas may generate at least one fringe pattern. A fringe pattern may allow having several parts with a sufficient high slope which can be used for classifying of out-of-line pixels. The term “fringe pattern” as used herein is a broad term and is to be given its ordinary and customary meaning to a person of ordinary skill in the art and is not to be limited to a special or customized meaning. The term specifically may refer, without limitation, to a characteristic of the object's spectrum of having signal intensities continuously varying with signal wavelength. The fringe pattern having signal intensities continuously varying with signal wavelength may not exclude the possibility of having wavelength spots in the spectrum of the object where the signal intensity does not vary locally with signal wavelength, such as maxima or minima of the signal intensity in the object's spectrum. The fringe patter may specifically comprise periodic variations in the signal intensity of the object's spectrum. As an example, the fringe pattern may comprise variation in the object's spectrum following a sine or cosine behavior. The fringe pattern may be a regular fringe pattern, such as a pattern having constant periodicity, or an irregular fringe pattern, having varying periodicity. In order to identify out-of-line pixels, it may be advantageous to measure a material that has as many dynamic, such as falling or rising, spectral areas as possible, such as materials that show a fringe pattern. In particular, the method may comprise determining if two pixels generate the same signal, although it is expected that a slope in the spectrum is different. This may be possible in case of measuring object with many dynamics.

The term “reference spectrum” as used herein is a broad term and is to be given its ordinary and customary meaning to a person of ordinary skill in the art and is not to be limited to a special or customized meaning. The term specifically may refer, without limitation, to a spectrum used as reference. The reference spectrum may be a spectrum obtained from the measured spectrum by using the processor. The reference spectrum may be a signal recorded with a reference device, e.g. a “gold standard”. The reference spectrum may be taken from literature or metrology institutions, or others.

For example, the reference spectrum S_{F,i} may be determined from the signals Sᵢ by applying at least one smoothing filter to the signals Sᵢ. The smoothing filter may be at least one filter selected from the group consisting of: a Savitzky-Golay filter, a polynomial of order n with n>4, moving average filter, local regression smoothing, low pass filtering, or other filters in pixel-space or Fourier space. For example, in step a), a smoothing filter is applied to the signals Sᵢ. For example, a Savitzky-Golay filter may be used, which least-square fits a signal at position i and adjacent signals with a polynomial of order n.

The term “processor” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processor may be configured for processing basic instructions that drive the computer or system. The processor may be or may comprise at least one of an integrated circuit, in particular an application-specific integrated circuit (ASIC), or a data processing device, in particular at least one of a digital signal processor (DSP), a field programmable gate array (FPGA), a microcontroller, a microcomputer, a computer, or an electronic communication unit, specifically a smartphone or a tablet. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for performing one or more evaluation operations. Further components may be feasible, in particular at least one preprocessing device or data acquisition device. The processor may, preferably, be configured to perform at least one computer program, in particular at least one computer program performing or supporting the steps of the method according to the present invention.

The processor may comprise at least one communication interface, in particular at least one of a wireless interface or a wire-bound interface. Further, the processor can be designed to, completely or partially, control or drive further devices, such as the at least one photodetector. Information as determined by the processor may, in particular, be provided to at least one of a further apparatus, or to a user, preferably in at least one of an electronic, visual, acoustic, or tactile fashion. Further, the information may be stored in at least one data storage unit, specifically in an internal data storage unit as comprised by the photodetector or at least the spectrometer, in particular by the at least one processor, or in an separate storage unit to which the information may be transmitted via the at least one communication interface. The separate storage unit may be comprised by the at least one electronic communication unit. The storage unit may in particular be configured for storing at least one electronic table, such as at least one look-up table. The term “data storage unit” as used herein is a broad term and is to be given its ordinary and customary meaning to a person of ordinary skill in the art and is not to be limited to a special or customized meaning. The term specifically may refer, without limitation, to an arbitrary memory device configured to store data. Specifically, the data storage unit may be an electronic, magnetic and/or mechanic memory device. The data storage unit may further be configured to store data, specifically in an organized way, such as in a database, more specifically in at least one database record.

The communication interface may be configured for transmitting data at least one of from or to or within the processor. The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may comprise at least one web interface.

The processor may be at least partially cloud-based. The term “cloud-based” as used herein is a broad term and is to be given its ordinary and customary meaning to a person of ordinary skill in the art and is not to be limited to a special or customized meaning. The term specifically may refer, without limitation, to an outsourcing of the processor or of parts of the processor to at least partially interconnected external devices, specifically computers or computer networks having larger computing power and/or data storage volume. The external devices may be arbitrarily spatially distributed. The external devices may vary over time, specifically on demand. The external devices may be interconnected by using the internet. The external devices may each comprise at least one communication interface.

The term “quantifier” as used herein is a broad term and is to be given its ordinary and customary meaning to a person of ordinary skill in the art and is not to be limited to a special or customized meaning. The term specifically may refer, without limitation, to a measure for quantifying a deviation between a measured spectrum and the reference spectrum. The quantifier may be determined by

$${C}_{i} = \frac{f ( {S}_{F , i} - {S}_{i} )}{g ( {σ}_{F , i} , {σ}_{i} )} ,$$

For example, the quantifier may be determined by

$${C}_{i} = \frac{{\vert {S}_{F , i} - {S}_{i} \vert}^{n}}{\sqrt[n]{{σ}_{F , i}^{n} + {σ}_{i}^{n}}} ,$$

with n being the power, σ_{F,i} being the standard deviation of the reference spectrum and σᵢ being the standard deviation of the measured signal of the pixel i. Alternatively or additionally, the quantifier may be determined according above-identified equation using weighting factors for one or more of σ_{F,i} and σᵢ. The standard deviation for a signal of the pixel may be determined by using the plurality of signals determined for said pixel. For example, the quantifier is determined with n=2 by

$${C}_{i} = \frac{{\vert {S}_{F , i} - {S}_{i} \vert}^{2}}{\sqrt{{σ}_{F , i}^{2} + {σ}_{i}^{2}}} .$$

The quantifier Cᵢ of a pixel may be compared to a limit Cₘₐₓ. The pixel may fail this criterion once

$${C}_{i} \geq {C}_{max} .$$

In case of Cᵢ≥Cₘₐₓ, the pixel i may be classified as out-of-line. Accordingly, the proposed method allows for providing a significance rating for the identification of out-of-line pixels by comparing the detected spectrum Sᵢ to a smoothed spectrum, which is generated from Sᵢ. This technique can be used to differentiate an out-of-line pixel from noise.

The out-of-line pixels may not be confused with noise (noisy pixels). Noisy pixels are pixels generating too little or too high signal but not due to electrical or optical errors or systematic or stochastic fluctuations. In order to ensure a highly reliable out of-line-pixel detection, the method may comprise performing a two-step check. In addition to step b), the method may comprise analyzing the signal behavior around the pixel position i. The method may comprise searching for a pre-defined number of out-of-line pixels in a row, in particular out-of-line neighboring pixels. The analyzing the signal behavior around the pixel position i may comprise testing one or more criteria Cⱼ. A group of pixels, also denoted as pixel cluster, at positions i+1, . . . i+N, with N being the pre-defined number, may be considered out-of-line if every separate criteria Cⱼ for an out-of-line pixel is fulfilled, combined into one C

$$C = {C}_{1} \hat{} {C}_{2} \hat{} … {C}_{N} .$$

For example, for N=2, the method may comprise searching for two short-circuited pixels. For example, for N=3, the method may comprise searching for three short-circuited pixels, in particular the method comprises if pixel i+1 is connected with pixel i+3. The method may comprise using a plurality of criteria. In some embodiments, a pixel may be considered as out-of-line in case all of the criteria are fulfilled. In some embodiments, a pixel may be considered as out-of-line in case a subset of the criteria is fulfilled. The method steps a) and b) may be performed before analyzing of the signal behavior around the pixel position i. Alternatively, as will be outlined in more detail below, the analyzing of the signal behavior around the pixel position i may be performed without performing steps a) and b).

For example, the method may comprise a linearity criterion. The analyzing the signal behavior around the pixel position i may comprise comparing a local derivative of the signal Sᵢ₊₁−Sᵢ to a derivative at the neighboring pixels. The change of the derivative in the signal is limited by the optical resolution of the spectrometer system. By comparing the local derivative in the spectrum between neighboring pixels, an additional outlier criterion is defined. When the derivatives show a large fluctuation around pixel i+1 . . . i+N then the group of pixels could be out-of-line. For example, pixel i+1, . . . i+N are classified as out-of-line if

$$\frac{\vert ( {S}_{i} - {S}_{i + 1} ) + ( {S}_{i + N} - {S}_{i + 1 + N} ) \vert}{{t}_{d}} > 2 \vert {S}_{i + 1} - {S}_{i + N} \vert .$$

This can be rewritten as

$$\frac{\vert ( {S}_{i + 1} - {S}_{i} ) + ( {S}_{i + 1 + N} - {S}_{i + N} ) \vert}{2 \vert {S}_{i + N} - {S}_{i + 1} \vert} > {t}_{d} ,$$

with t_{d} being at least one predefined threshold. The term “predefined threshold” as used herein is a broad term and is to be given its ordinary and customary meaning to a person of ordinary skill in the art and is not to be limited to a special or customized meaning. The term specifically may refer, without limitation, to a numerical value used as a reference value for classification of the pixels. Specifically, the classification may refer to the out-of-line characteristic of the pixels. If above-identified criterion exceeds the numerical value of the predefine threshold, the corresponding pixels may be classified as out-of-line. However, if above-identified criterion is equal or below the predefined threshold, the corresponding pixels may be not classified as out-of-line. The predefined threshold may be a fixed numerical value. The predefined threshold may be defined prior to performing the method, specifically prior to step b). The predefined threshold t_{d} may be selected to specify an intensity at which an out-of-line pixel shall be recognized as such. In particular, the predefined threshold may be selected for allowing distinguishing noise from out-of-line pixels or determining that the out-of-line pixel can be ignored because it does not significantly influence the measurement. For example, the t_{d} may be in the range from 1.5 to 1.7.

For example, the method may comprise a peak skip criterion. The analyzing the signal behavior around the pixel position i may comprise comparing the sign of a local derivative at pixel i to signs of derivatives of the neighboring pixels. Pixel i+1, . . . i+N may be classified as out-of-line if

$$f ( {S}_{i} - {S}_{i + 1} ) * g ( {S}_{i + N} - {S}_{i + 1 + N} ) > 0 ,$$

wherein f and g are arbitrary functions, such as linear functions, polynomial functions and/or power law functions. As an example, pixel i+1, . . . i+N may be classified as out-of-line if

$$( {S}_{i} - {S}_{i + 1} ) * ( {S}_{i + N} - {S}_{i + 1 + N} ) > 0 .$$

This can be rewritten as

$$( {S}_{i + 1} - {S}_{i} ) * ( {S}_{i + 1 + N} - {S}_{i + N} ) > 0 .$$

Thus, the peak skip criterion may comprise comparing the sign of the local derivative at pixel i to the derivate of the neighboring pixels, essentially searching for a zero-crossing of the derivate, i.e., a saddle point of the signal.

For example, the method may comprise a slope ratio criterion. The analyzing the signal behavior around the pixel position i comprises comparing fluctuation in the derivatives around pixel i. Pixel i+1, . . . i+N may be classified as out-of-line if

$$\vert f ( {S}_{i} - {S}_{i + 1} ) - g ( {S}_{i + N} - {S}_{i + 1 + N} ) \vert < a * \vert h ( {S}_{i} - {S}_{i + 1} ) + i ( {S}_{i + N} - {S}_{i + 1 + N} ) \vert ,$$

with f, g, h and i being arbitrary functions, such as linear functions, polynomial functions and/or power law functions and a∈ [symbol] example, pixel i+1, . . . i+N may be classified as out-of-line if

$$\vert ( {S}_{i} - {S}_{i + 1} ) - ( {S}_{i + N} - {S}_{i + 1 + N} ) \vert < \frac{1}{2} \vert ( {S}_{i} - {S}_{i + 1} ) + ( {S}_{i + N} - {S}_{i + 1 + N} ) \vert$$

This can be rewritten as

$$\frac{\vert ( {S}_{i + 1} - {S}_{i} ) - ( {S}_{i + 1 + N} - {S}_{i + N} ) \vert}{\vert ( {S}_{i + 1} - {S}_{i} ) + ( {S}_{i + 1 + N} - {S}_{i + N} ) \vert} < \frac{1}{2}$$

Thus, the slope ratio criterion may comprise comparing the fluctuation of the derivate (which is similar to the second derivative). The slope ratio criterion may comprise checking if the out-of-line pixel cluster on both sides changes sufficiently symmetrically over into the slope.

If the significance rating of step b) is performed and, optionally, one or more of the mentioned criteria are checked, all out-of-line pixels can be reliably identified and automatically masked.

The method steps a) and b) may be performed by using the fringe pattern, in particular a first fringe pattern. Steps a) and b), and optionally additionally one or more of the checks for the mentioned criteria, may be repeated with a second fringe pattern with a phase offset of the first measured spectrum. This may allow that the peak and valley areas of the first pattern are also covered by dynamic areas of the second pattern.

The method comprises at least one measurement step, in particular subsequent to steps a) and b). The measurement step comprises determining at least one spectrum using the photodetector. The masked pixels may be ignored or mathematically corrected using neighboring pixels.

In a further aspect of the present invention, a method for automated quality control of at least one photodetector is disclosed.

The photodetector comprises a plurality of pixels i, with i being a pixel position and i>2, wherein each pixel comprises at least one photosensitive region. Each of the pixels is configured for generating a signal in response to illumination by optical radiation of its respective photosensitive region.

The method comprises classifying of out-of-line pixels by analyzing a signal behavior around a pixel position i, wherein the analyzing comprises testing one or more of the following criteria Cⱼ,
i) a linearity criterion, wherein a local derivative of a measured signal is compared to a derivative of neighboring pixels;
ii) a peak skip criterion, wherein a sign of a local derivative at pixel i is compared to signs of derivatives of the neighboring pixels;
iii) a slope ratio criterion, wherein fluctuation in derivatives around pixel i are compared to each other.

For definitions and possible embodiments of the method or parts thereof, reference is made to the definitions and embodiments as described with respect to the method as described in a first aspect.

A group of pixels at positions i+1, . . . i+N, with N being the pre-defined number, may be considered out-of-line if every separate criteria Cᵢ₎, Cᵢᵢ₎ and Cᵢᵢᵢ₎, for an out-of-line pixel is fulfilled, combined into one C

$$C = {C}_{i )} ∧ {C}_{i i )} ∧ {C}_{i i i )} .$$

These criteria may allow reliable detection of weak out-of-line pixels, in particular detecting out-of-line pixels within noise. These criteria may be in particular suitable in low frequency (e.g. high resolution) spectra such as a fringe pattern.

The method may comprise using further criteria, such as using the quantifier Cᵢ, as described above. For example, the quantifier Cᵢ may be determined by

$${C}_{i} = \frac{{\vert {S}_{F , i} - {S}_{i} \vert}^{n}}{\sqrt[n]{{σ}_{F , i}^{n} + {σ}_{i}^{n}}} ,$$

with n being the power, σ_{F,i} being the standard deviation of the reference spectrum and σᵢ being the standard deviation of the measured signal of the pixel i. Alternatively or additionally, the quantifier may be determined according above-identified equation using weighting factors for one or more of σ_{F,i} and σᵢ. The standard deviation for a signal of the pixel may be determined by using the plurality of signals determined for said pixel. For example, the quantifier is determined with n=2 by

$${C}_{i} = \frac{{\vert {S}_{F , i} - {S}_{i} \vert}^{2}}{\sqrt{{σ}_{F , i}^{2} + {σ}_{i}^{2}}} .$$

The quantifier Cᵢ of a pixel may be compared to a limit Cₘₐₓ. The pixel may fail this criterion once

$${C}_{i} \geq {C}_{max} .$$

In case of Cᵢ≥Cₘₐₓ, the pixel i may be classified as out-of-line. Accordingly, the proposed method allows for providing a significance rating for the identification of out-of-line pixels by comparing the detected spectrum Sᵢ to a smoothed spectrum, which is generated from Sᵢ. This technique can be used to differentiate an out-of-line pixel from noise.

The method may comprise using a plurality of criteria. In some embodiments, a pixel may be considered as out-of-line in case all of the criteria are fulfilled. In some embodiments, a pixel may be considered as out-of-line in case a subset of the criteria is fulfilled.

The method may be computer-implemented.

Further disclosed and proposed herein is a computer program including computer-executable instructions for performing one or more of the methods according to the present invention in one or more of the embodiments enclosed herein when the program is executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps, such as a) to b), as indicated above may be performed by using a computer or a computer network, preferably by using a computer program.

Further disclosed and proposed herein is a computer program product having program code means, in order to perform one or more of the methods according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute one or more of the methods according to one or more of the embodiments disclosed herein.

Further disclosed and proposed herein is a computer program product with program code means stored on a machine-readable carrier, in order to perform one or more of the methods according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing one or more of the methods according to one or more of the embodiments disclosed herein.

Referring to the computer-implemented aspects of the invention, one or more of the method steps or even all of the method steps of one or more of the methods according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the methods according to one of the embodiments described in this description,
a computer loadable data structure that is adapted to perform the methods according to one of the embodiments described in this description while the data structure is being executed on a computer,
a computer program, wherein the computer program is adapted to perform the methods according to one of the embodiments described in this description while the program is being executed on a computer,
a computer program comprising program means for performing the methods according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

In a further aspect of the present invention, a photodetector for measuring optical radiation is disclosed. The photodetector is configured for performing one or more of the methods according to the present invention, such as according to any one of the embodiments disclosed above and/or according to any one of the embodiment disclosed in further detail below. The photodetector comprises a plurality of pixels i, with i being a pixel position and i>2, wherein each pixel comprises at least one photosensitive region. Each of the pixels is configured for generating a signal in response to illumination by optical radiation of its respective photosensitive region. The photodetector comprises at least one readout electronics unit. For definitions and possible embodiments of the photodetector or parts thereof, reference is made to the definitions and embodiments as described with respect to the methods.

In a further aspect of the present invention, a spectrometer for spectrally analyzing optical radiation provided by at least one measurement object is disclosed. The spectrometer comprises:
at least one radiation source configured for emitting optical radiation at least partially towards the object; and
at least one photodetector according to the present invention, such as according to any one of the embodiments disclosed above and/or according to any one of the embodiment disclosed in further detail below.

The spectrometer may be a reflection spectrometer device or a transmission spectrometer device.

The spectrometer may further comprise at least one optical element. The optical element may be positioned in a beam path before the photodetector. The optical element may comprise at least one wavelength selective element. The term “wavelength selective element” as used herein is a broad term and is to be given its ordinary and customary meaning to a person of ordinary skill in the art and is not to be limited to a special or customized meaning. The term specifically may refer, without limitation, to an optical element configured for selectively transmitting light of different wavelengths. Specifically, the wavelength selective element may be configured for transmitting an incident light beam, whereby a spectral composition of the incident light may be modified upon transmission. The modification of the transmitted light may comprise one or more of: a spatial separation of light having different wavelengths; an attenuation of light having different wavelengths. For example, the wavelength selective element may be configured for selectively transmitting light in a particular range of wavelengths, while absorbing, filtering and/or interfering the remainder. The wavelength selective element may comprise at least one element selected from the group consisting of: a prism; a grating; a linear variable filter; an optical filter.

For further details regarding to the spectrometer, reference may be made to the description of the photodetector and the method above and as described in more detail below.

In a further aspect of the present invention, a use of a spectrometer according to any one of the embodiments described above or below in further detail referring to a spectrometer is disclosed for a purpose of use, selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present.

As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1. A method for automated quality control of at least one photodetector comprising a plurality of pixels i, with i being a pixel position and i>2, wherein each pixel comprises at least one photosensitive region, wherein each of the pixels is configured for generating a signal in response to illumination by optical radiation of its respective photosensitive region, wherein the method comprises classifying of out-of-line pixels by
a) measuring a plurality of signals Sᵢ for the pixels by measuring at least one object using the photodetector;
b) by using at least one processor, comparing the measured signals Sᵢ and at least one reference spectrum S_{F,i}, determining at least one quantifier Cᵢ for each pixel i quantifying a deviation between the respective measured signal Sᵢ and the reference spectrum S_{F,i}, and comparing the respective quantifier Cᵢ to at least one threshold Cₘₐₓ, wherein a pixel is classified as out-of-line pixel in case the respective quantifier Cᵢ exceeds the limit Cₘₐₓ.

Embodiment 2. The method according to the preceding embodiment, wherein the method comprises determining a measured spectrum by using the signals Sᵢ of the pixels, wherein the reference spectrum S_{F,i} is determined by the processor from the signals Sᵢ by applying at least one smoothing filter to the signals Sᵢ, wherein the smoothing filter is at least one filter selected from the group consisting of: a Savitzky-Golay filter, a polynomial of order n with n>4, moving average filter, local regression smoothing, low pass filtering, or other filters in pixel-space or Fourier space.
Embodiment 3. The method according to any one of the preceding embodiments, wherein the quantifier is determined by

$${C}_{i} = \frac{{\vert {S}_{F , i} - {S}_{i} \vert}^{n}}{\sqrt[n]{{σ}_{F , i}^{n} + {σ}_{i}^{n}}} ,$$

with σ_{F,i} being the standard deviation of the reference spectrum and σ_{g} being the standard deviation of the measured signal of the pixel i.

Embodiment 4. The method according to any one of the preceding embodiments, wherein in case of Cᵢ≥Cₘₐₓ, the pixel i is classified as out-of-line.

Embodiment 5. The method according to any one of the preceding embodiments, wherein the method further comprises analyzing the signal behavior around the pixel position i.

Embodiment 6. The method according to the preceding embodiment, wherein the method comprises searching for a pre-defined number of out-of-line pixels in a row, wherein a group of pixels at positions i+1, . . . i+N, with N being pre-defined number, is considered out-of-line if every separate criteria Cⱼ for an out-of-line pixel is fulfilled, combined into one C

$$C = {C}_{1} ∧ {C}_{2} ∧ … {C}_{N} .$$

Embodiment 7. The method according to any one of the preceding embodiment, wherein the method comprises a linearity criterion, wherein the analyzing the signal behavior around the pixel position i comprises comparing a local derivative of the signal Sᵢ₊₁−Sᵢ to a derivative at the neighboring pixels.

Embodiment 8. The method according to any one of the two receding embodiments, wherein the group of pixels is classified as out-of-line in case

$$\frac{\vert ( {S}_{i + 1} - {S}_{i} ) + ( {S}_{i + 1 + N} - {S}_{i + N} ) \vert}{2 \vert {S}_{i + N} - {S}_{i + 1} \vert} > {t}_{d} ,$$

with t_{d} being at least one predefined threshold.

Embodiment 9. The method according to any one of the three preceding embodiments, wherein the method comprises a peak skip criterion, wherein the analyzing the signal behavior around the pixel position i comprises comparing the sign of a local derivative at pixel i to signs of derivatives of the neighboring pixels.

Embodiment 10. The method according to any one of the four preceding embodiments, wherein the group of pixels is classified as out-of-line in case

$$( {S}_{i + 1} - {S}_{i} ) * ( {S}_{i + 1 + N} - {S}_{i + N} ) > 0 .$$

Embodiment 11. The method according to any one of the five preceding embodiments, wherein the method comprises a slope ratio criterion, wherein the analyzing the signal behavior around the pixel position i comprises comparing fluctuation in the derivatives around pixel i, wherein pixel i+1, . . . i+N are classified out-of-line if

$$\frac{\vert ( {S}_{i + 1} - {S}_{i} ) - ( {S}_{i + 1 + N} - {S}_{i + N} ) \vert}{\vert ( {S}_{i + 1} - {S}_{i} ) + ( {S}_{i + 1 + N} - {S}_{i + N} ) \vert} < \frac{1}{2} .$$

Embodiment 12. The method according to any one of the preceding embodiments, wherein the object comprises at least one material having a plurality of dynamic spectral areas, e.g. such that at least one fringe pattern is generated.

Embodiment 13. The method according to the preceding embodiment, wherein the method is repeated with a second fringe pattern with a phase offset of the spectrum.

Embodiment 14. The method according to any one of the preceding embodiments, wherein the method comprises masking all pixels which are classified as out-of-line.

Embodiment 15. The method according to the preceding embodiment, wherein the method comprises at least one measurement step, wherein the measurement step comprises determining at least one spectrum using the photodetector, wherein the masked pixels are ignored or mathematically corrected using neighboring pixels.

Embodiment 16. The method according to anyone of the preceding embodiments, wherein the method is computer-implemented.

Embodiment 17. A method for automated quality control of at least one photodetector, wherein the photodetector comprises a plurality of pixels i, with i being a pixel position and i>2, wherein each pixel comprises at least one photosensitive region, wherein each of the pixels is configured for generating a signal in response to illumination by optical radiation of its respective photosensitive region, wherein the method comprises classifying of out-of-line pixels by analyzing a signal behavior around a pixel position i, wherein the analyzing comprises testing one or more of the following criteria Cⱼ,
i) a linearity criterion, wherein a local derivative of a measured signal is compared to a derivative of neighboring pixels;
ii) a peak skip criterion, wherein a sign of a local derivative at pixel i is compared to signs of derivatives of the neighboring pixels;
iii) a slope ratio criterion, wherein fluctuation in derivatives around pixel i are compared to each other.

Embodiment 18. The method according to the preceding embodiment, wherein the method is computer-implemented.

Embodiment 19. A photodetector for measuring optical radiation, the photodetector being configured for performing the method according to any one of the preceding embodiments referring to a method, wherein the photodetector comprises a plurality of pixels i, with i being a pixel position and i>2, wherein each pixel comprises at least one photosensitive region, wherein each of the pixels is configured for generating a signal in response to illumination by optical radiation of its respective photosensitive region, wherein the photodetector comprises at least one readout electronics unit.

Embodiment 20. A spectrometer for spectrally analyzing optical radiation provided by at least one object, the spectrometer comprising:
at least one radiation source configured for emitting optical radiation at least partially towards the object; and
at least one photodetector according to the preceding embodiment.

Embodiment 21. A computer program comprising instructions which, when the program is executed by the photodetector according to embodiment 19, cause the photodetector to perform one or more of the methods according to any one of the preceding embodiments referring to a method.

Embodiment 22. A computer-readable storage medium comprising instructions which, when the instructions are executed by the photodetector according to embodiment 19, cause the photodetector to perform one or more of the methods according to any one of the preceding embodiments referring to a method.

Embodiment 23. A non-transient computer-readable medium including instructions that, when executed by one or more processors, cause the one or more processors to perform one or more of the methods according to any one of the preceding embodiments referring to a method.

Embodiment 24. Use of a spectrometer according to embodiment 20 for a purpose of use, selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 show embodiments of a spectrometer for spectrally analyzing optical radiation provided by at least one object and of a photodetector for measuring optical radiation;

FIGS. 2A and 2D show exemplary spectra of a PET sample;

FIG. 3 shows a flow chart of an embodiment of method for automated quality control of at least one photodetector; and

FIG. 4 shows an embodiment of a fringe pattern used for the method of FIG. 3.

### DETAILED DESCRIPTION OF THE EMBODIMENTS

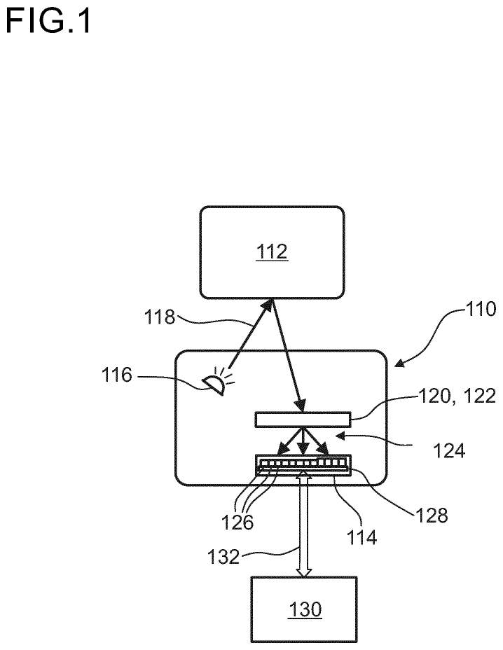

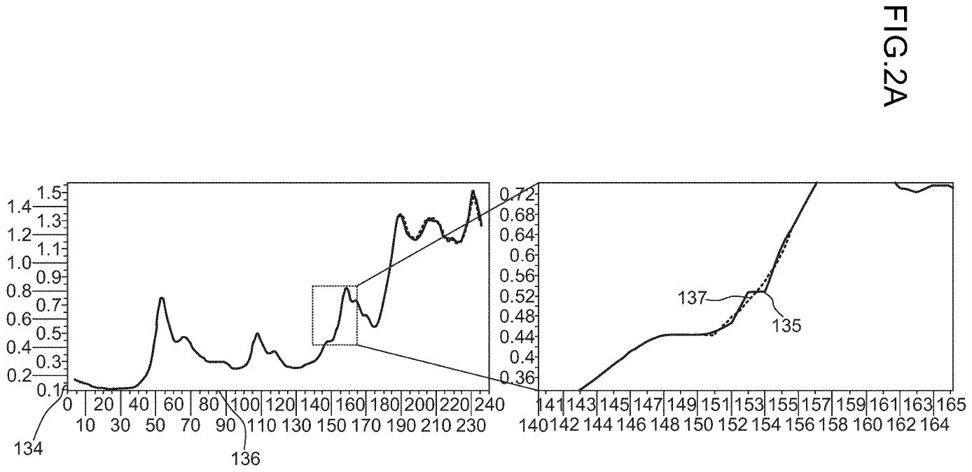

FIG. 1 show exemplary embodiments of a spectrometer 110 for spectrally analyzing optical radiation provided by at least one object 112 and of a photodetector 114 for measuring optical radiation. As can be seen in FIG. 1, the spectrometer 110 comprises besides the photodetector 114 at least one radiation source 116 configured for emitting optical radiation 118 at least partially towards the object 112. The radiation source 116 may comprise at least one of a semiconductor-based radiation source or a thermal radiator. The at least one semiconductor-based radiation source may be selected from at least one of a light emitting diode (LED) or a laser, specifically a laser diode. The LED may comprise at least one fluorescent and/or phosphorescent material. The thermal radiator may comprise at least one of an incandescent lamp, a black body emitter and a microelectromechanical system (MEMS) emitter. However, other types of radiation sources are also feasible. As can be seen in FIG. 1, the exemplary embodiment of the spectrometer 110 is a reflection spectrometer and the radiation source 116 may be an internal radiation source, specifically being comprised by the spectrometer 110 with the other components of the spectrometer 110 within a housing. However, the spectrometer 110 may also be a transmission spectrometer and the radiation source 116 may be an external radiation source.

The spectrometer 110 may further comprise at least one optical element 120. The optical element 120 may be positioned in a beam path before the photodetector 114. The optical element 120 may comprise at least one wavelength selective element 122. For example, the wavelength selective element 122 may be configured for selectively transmitting light in a particular range of wavelengths, while absorbing, filtering and/or interfering the remainder. The wavelength selective element 122 may comprise at least one element selected from the group consisting of: a prism; a grating; a linear variable filter; an optical filter. As shown in FIG. 1, the optical radiation 118 reflected by the object 112 may be selectively transmitted by the optical element 120 towards the photodetector 114. Upon transmitting the optical radiation 118 to the photodetector 114, the optical element 120 may be configured for separating incident optical radiation 118 into a spectrum of constituent wavelength components 124.

The photodetector 114 comprises a plurality of pixels i (denoted by reference number 126), with i being a pixel position and i>2. Each pixel 126 comprises at least one photosensitive region. Each of the pixels 126 is configured for generating a signal in response to illumination by optical radiation 118 of its respective photosensitive region. In the exemplary embodiment of FIG. 1, the plurality of pixels 126 of the photodetector 114 are arranged in an array of pixels 126, specifically in a linear array of pixels 126. However, other types of arrangements, such as matrices or the like, are also feasible.

The photodetector 114 comprises at least one readout electronics unit 128. The readout electronics unit 128 may comprise at least one of: an operational amplifier; an analog-to-digital converter; a voltage divider; a current divider, an ASIC, specifically for subtracting a constant current for generating a signal current.

The spectrometer 110 may further comprise at least one processor 130. The processor 130 may be at least partially cloud-based. The processor 130 may comprise at least one communication interface 132, in particular at least one of a wireless interface or a wire-bound interface. The communication interface 132 may be configured for transmitting data at least one of from or to or within the processor 130. For example, as shown in FIG. 1, the communication interface 132 may be configured for transmitting data, specifically spectral data, such as the plurality of signals for the pixels 126, from the photodetector 114, specifically from the readout electronics unit 128, to the processor 130 being at least partially cloud-based via a wireless connection.

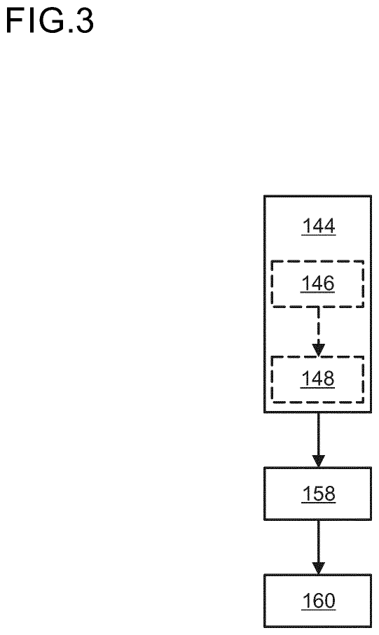

The photodetector 114 is configured for performing a method for automated quality control of at least one photodetector 114 comprising a plurality of pixels 126. Specifically, the photodetector 114 may be configured for performing the method according to the embodiment shown in FIG. 3. Thus, for a description of the method, reference is made to the description of FIG. 3. Further, the photodetector 114 may also be configured for performing the method in any other possible embodiment disclosed herein.

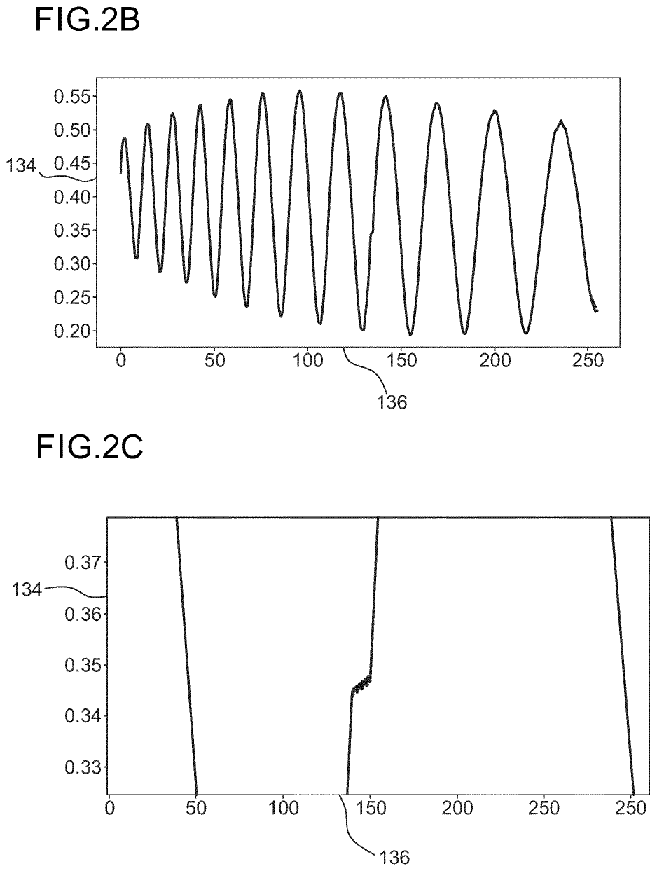

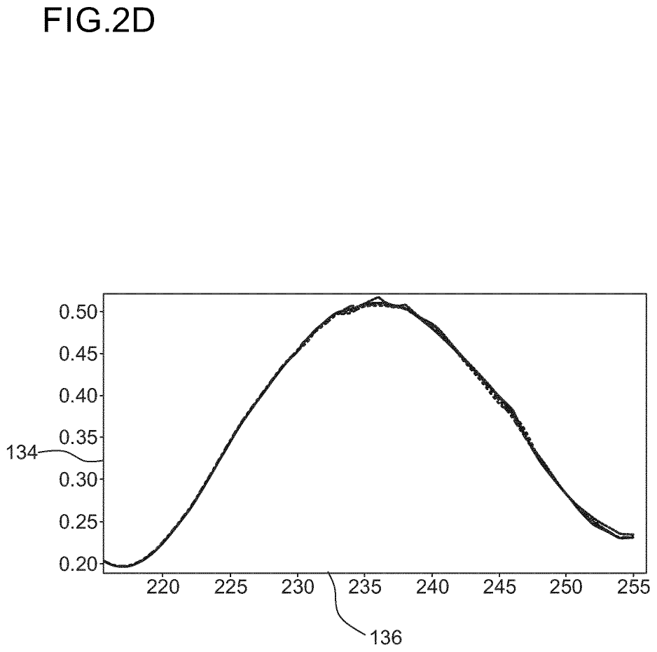

FIGS. 2A to 2D show exemplary spectra of a PET sample. The spectra shown in FIG. 2A to 2D may be measured using a spectrometer 110 according to the present invention, such as a spectrometer 110 as exemplarily shown in FIG. 1. In this example, the photodetector 114 comprises a linear array of 256 pixels 126, wherein the pixels 126 comprise PbS as photoconductive material.

FIG. 2A shows the absorbance 134 of a PET sample as a function of the pixel position i 136. Specifically, as can be seen in the enlarged view in FIG. 2A, the diagram shows the absorbance for five sample measurements (denoted by reference number 135) and the absorbance after smoothing with a Savitzky-Golay filter (denoted by reference number 137). As will be outlined in further detail below, the filtered measurements 137 may be used as a reference spectrum S_{F,i}. Further, as can be seen best in the enlarged view of FIG. 2A, signals from some of the pixels 126 may deviate from the expected curve of the PET sample and, thus, represent out-of-line pixels. In this example, the pixels with position i=154 and i=155 represent out-of-line pixels. The pixels with positions i=200 and upwards may be noisy pixels.

FIGS. 2B to 2D show for comparison noise and a pair of out-of-line pixel. In particular, the pair of out-of-line pixel shows that an out-of-line pixel must not be a 100% short circuit (identical absorbances) but that, in case of high ohmic short circuits, out-of-line pixel may cause only small distortions.

In FIG. 2B, similar to FIG. 2A, the absorbance 134 is shown as a function of the pixel position i 136. Pixels 134 to 135 are out-of-line pixel. Starting with pixel 235 noise is dominant such that these pixels have to be ignored, because they likely be random outliers. FIG. 2C shows a zoom into a region of out-of-line pixels with high signal to noise ratio. FIG. 2D shows a zoom into a region of out-of-line pixels with low signal to noise ratio. In order to reliably detect if these pixels are out-of-line pixels, the method for automated quality control of at least one photodetector 114 may be performed as exemplarily shown in FIG. 3.

FIG. 3 shows a flow chart of an exemplary embodiment of method for automated quality control of at least one photodetector 114. The photodetector 114 may be embodied as shown in FIG. 1. Thus, for a description of the photodetector 114, reference is made to the description of FIG. 1.

The method comprises classifying of out-of-line pixels (denoted by reference number 144) by
a) (denoted by reference number 146) measuring a plurality of signals Sᵢ for the pixels 126 by measuring the at least one object 112 using the photodetector 114 and, optionally, determining a reference spectrum S_{F,i} from the respective measured signals Sᵢ by using the at least one processor 130;
b) (denoted by reference number 148) by using the processor 130, comparing the measured signals Sᵢ and the reference spectrum S_{F,i}, determining at least one quantifier Cᵢ for each pixel i 126 quantifying a deviation between the respective measured signal Sᵢ and the reference spectrum S_{F,i}, and comparing the respective quantifier Cᵢ to at least one threshold Cₘₐₓ, wherein a pixel 126 is classified as out-of-line pixel in case the respective quantifier Cᵢ exceeds the limit Cₘₐₓ.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion. The method may comprise repeating steps a) and b) at pre-defined times or continuously.

The signal Sᵢ may be a signal generated by the pixel i 126 in response to illumination. The method may comprise measuring a plurality of signals Sᵢ for each of the pixels i 126, e.g. by repeatedly measuring the object 112 with the photodetector 114. For example, the method may comprise measuring two, three, four, five, up to ten or even more measurements for each pixel i 126. The method may comprise determining a plurality of measured spectra by using the signals of the pixels 126 as a function of the pixels i 126. For example the measured spectrum may be determined by, in case of a modulated radiation source, recording a plurality of imaging frames, e.g. 1000 imaging frames. A plurality of signals (depending on the modulation frequency) of the photodetector may be measured with and without illumination. These signals may be evaluated, e.g. by using one or more of at least one FFT or DFT. The evaluation may further comprise using a standard white measurement thereby determining a measured spectrum. For example, the measured spectrum may be determined by determining a mean value of the signals of the pixels over time. The method may comprise, e.g. during step a) and/or by repeating step a), determining a plurality of spectra. These measured spectra may be used for classifying whether the deviation (outlier) of the pixel under suspect results due to SNR or is systematically present and, thus, has to be classified as out-of-line pixel. Additionally, the reference spectrum S_{F,i} may be determined from the signals Sᵢ by applying at least one smoothing filter to the signals Sᵢ. The smoothing filter may be at least one filter selected from the group consisting of: a Savitzky-Golay filter, a polynomial of order n with n>4, moving average filter, local regression smoothing, low pass filtering, or other filters in pixel-space or Fourier space. For example, in step a), a smoothing filter is applied to the signals Sᵢ. For example, a Savitzky-Golay filter may be used, which least-square fits a signal at position i and adjacent signals with a polynomial of order n.

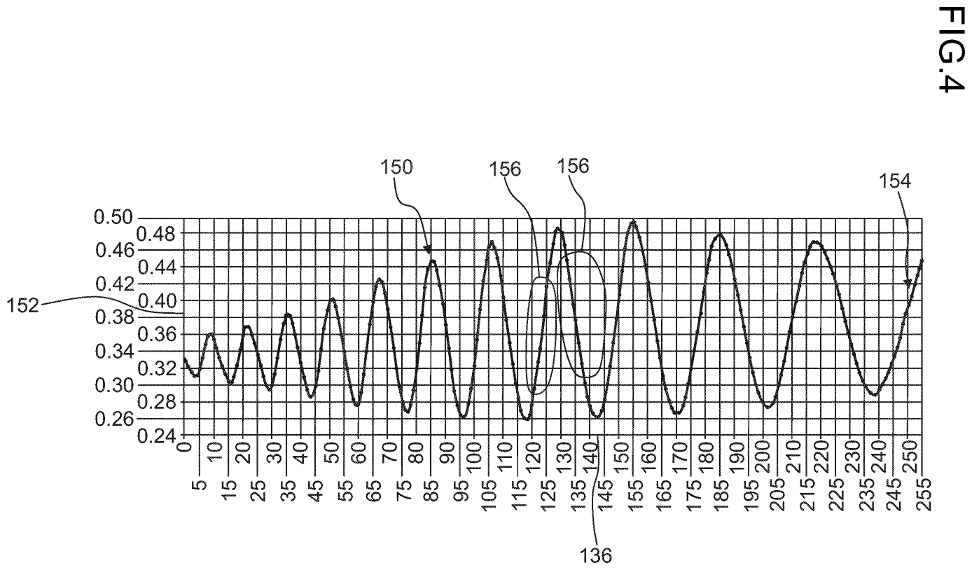

In the embodiment of the method of FIG. 3, the method steps a) and b) may specifically be performed by using a fringe pattern 150, in particular a first fringe pattern. FIG. 4 shows an exemplary embodiment of the fringe pattern 150 used for performing method steps a) and b). Specifically, in the diagram of FIG. 4, a signal intensity 152 is shown as a function of the pixel position i 136. Steps a) and b), and optionally additionally one or more of the checks for the criteria outlined in further detail below, may be repeated with a second fringe pattern with a phase offset of the first measured spectrum. This may allow that the peak and valley areas of the first pattern 150 are also covered by dynamic areas of the second pattern.

The quantifier may, as an example, be determined by

$${C}_{i} = \frac{{\vert {S}_{F , i} - {S}_{i} \vert}^{n}}{\sqrt[n]{{σ}_{F , i}^{n} + {σ}_{i}^{n}}} ,$$

with n being the power, σ_{F,i} being the standard deviation of the reference spectrum and σᵢ being the standard deviation of the measured signal of the pixel i 126. The standard deviation for a signal of the pixel 126 may be determined by using the plurality of signals determined for said pixel 126. For example, the quantifier is determined with n=2 by

$${C}_{i} = \frac{{\vert {S}_{F , i} - {S}_{i} \vert}^{2}}{\sqrt{{σ}_{F , i}^{2} + {σ}_{i}^{2}}} .$$

The quantifier Cᵢ of a pixel 126 may be compared to a limit Cₘₐₓ. The pixel 126 may fail this criterion once

$${C}_{i} \geq {C}_{max} .$$

In case of Cᵢ≥Cₘₐₓ, the pixel i 126 may be classified as out-of-line. Accordingly, the proposed method allows for providing a significance rating for the identification of out-of-line pixels by comparing the detected spectrum Sᵢ to a smoothed spectrum, which is generated from Sᵢ. This technique can be used to differentiate an out-of-line pixel from noise.

The out-of-line pixels may not be confused with noise (noisy pixels). Noisy pixels are pixels 126 generating too little signal but not due to electrical or optical errors. This can be seen in the diagram of FIG. 4. In FIG. 4, noisy pixels are denoted by reference number 154, whereas out-of-line pixels are marked by circles 156. The noisy pixels 154 from pixel position i=235 and upwards may be reliably identified using the significance rating of step b). These noisy pixels 154 may not be classified as pseudo out-of-line pixels. Thus, noisy pixels 154 can be differentiated from out-of-line pixels 156 by using the method according to the present invention although the short-circuited pixels at reference sign 156 is only week.

In order to ensure a highly reliable out of-line-pixel detection, the method may comprise performing a two-step check. In addition to step b), the method may comprise analyzing the signal behavior around the pixel position i 136 (denoted by reference number 158). The method may comprise searching for a pre-defined number of out-of-line pixels 126 in a row, in particular out-of-line neighboring pixels 126. The analyzing the signal behavior around the pixel position i 136 may comprise testing one or more criteria Cⱼ. A group of pixels, also denoted as pixel cluster, at positions i+1, . . . i+N 136, with N being the pre-defined number, may be considered out-of-line if every separate criteria Cⱼ for an out-of-line pixel is fulfilled, combined into one C

$$C = {C}_{1} ∧ {C}_{2} ∧ … {C}_{N} .$$

For example, for N=2, the method may comprise searching for two short-circuited pixels 126. For example, for N=3, the method may comprise searching for three short-circuited pixels 126, in particular the method comprises if pixel i+1 126 is connected with pixel i+3 126.

For example, the method may comprise a linearity criterion. The analyzing the signal behavior around the pixel position i 136 may comprise comparing a local derivative of the signal Sᵢ₊₁−Sᵢ to a derivative at the neighboring pixels 126. The change of the derivative in the signal is limited by the optical resolution of the spectrometer system. By comparing the local derivative in the spectrum between neighboring pixels, an additional outlier criterion is defined. When the derivatives show a large fluctuation around pixel i+1 . . . i+N 126 then the group of pixels could be out-of-line. For example, pixel i+1, . . . i+N 126 are classified as out-of-line if

$$\frac{\vert ( {S}_{i} - {S}_{i + 1} ) + ( {S}_{i + N} - {S}_{i + 1 + N} ) \vert}{{t}_{d}} > 2 \vert {S}_{i + 1} - {S}_{i + N} \vert .$$

This can be rewritten as

$$\frac{\vert ( {S}_{i + 1} - {S}_{i} ) + ( {S}_{i + 1 + N} - {S}_{i + N} ) \vert}{2 \vert {S}_{i + N} - {S}_{i + 1} \vert} > {t}_{d} ,$$

with t_{d} being at least one predefined threshold. The predefined threshold t_{d} may be selected to specify an intensity at which an out-of-line pixel shall be recognized as such. In particular, the predefined threshold may be selected for allowing distinguishing noise from out-of-line pixels. For example, the t_{d} may be in the range from 1.5 to 1.7.

For example, the method may comprise a peak skip criterion. The analyzing the signal behavior around the pixel position i 136 may comprise comparing the sign of a local derivative at pixel i 126 to signs of derivatives of the neighboring pixels 126. Pixel i+1, . . . i+N may be classified as out-of-line if

$$f ( {S}_{i} - {S}_{i + 1} ) * g ( {S}_{i + N} - {S}_{i + 1 + N} ) > 0 ,$$

wherein f and g are functions, such as linear functions, polynomial functions and/or power law functions. As an example, pixel i+1, . . . i+N 126 may be classified as out-of-line if

$$( {S}_{i} - {S}_{i + 1} ) * ( {S}_{i + N} - {S}_{i + 1 + N} ) > 0 .$$

This can be rewritten as

$$( {S}_{i + 1} - {S}_{i} ) * ( {S}_{i + 1 + N} - {S}_{i + N} ) > 0 .$$

Thus, the peak skip criterion may comprise comparing the sign of the local derivative at pixel i 126 to the derivate of the neighboring pixels 126, essentially searching for a zero-crossing of the derivate, i.e., a saddle point of the signal.

For example, the method may comprise a slope ratio criterion. The analyzing the signal behavior around the pixel position i 136 comprises comparing fluctuation in the derivatives around pixel i 126. Pixel i+1, . . . i+N may be classified as out-of-line if

$$\vert f ( {S}_{i} - {S}_{i + 1} ) - g ( {S}_{i + N} - {S}_{i + 1 + N} ) \vert < a * \vert h ( {S}_{i} - {S}_{i + 1} ) + i ( {S}_{i + N} - {S}_{i + 1 + N} ) \vert ,$$

with f, g, h and i being arbitrary functions, such as linear functions, polynomial functions and/or power law functions and a∈ [symbol] . For example, pixel i+1, . . . i+N 126 may be classified as out-of-line if

$$\vert ( {S}_{i} - {S}_{i + 1} ) - ( {S}_{i + N} - {S}_{i + 1 + N} ) \vert < \frac{1}{2} \vert ( {S}_{i} - {S}_{i + 1} ) + ( {S}_{i + N} - {S}_{i + 1 + N} ) \vert$$

This can be rewritten as

$$\frac{\vert ( {S}_{i + 1} - {S}_{i} ) - ( {S}_{i + 1 + N} - {S}_{i + N} ) \vert}{\vert ( {S}_{i + 1} - {S}_{i} ) + ( {S}_{i + 1 + N} - {S}_{i + N} ) \vert} < \frac{1}{2}$$

Thus, the slope ratio criterion may comprise comparing the fluctuation of the derivate (which is similar to the second derivative). The slope ratio criterion may comprise checking if the out-of-line pixel cluster on both sides changes sufficiently symmetrically over into the slope.

If the significance rating of step b) is performed and, optionally, one or more of the mentioned criteria are checked, all out-of-line pixels can be reliably identified and automatically masked. The method may further comprise at least one measurement step (denoted by reference number 160), in particular subsequent to steps a) and b). The measurement step 160 comprises determining at least one spectrum using the photodetector 114. The masked pixels may be ignored or mathematically corrected using neighboring pixels 126.

### LIST OF REFERENCE NUMBERS

110 spectrometer
112 object
114 photodetector
116 radiation source
118 optical radiation
120 optical element
122 wavelength selective element
124 constituent wavelength components
126 pixel
128 readout electronics unit
130 processor
132 communication interface
134 absorbance
135 five sample measurements of PET
136 pixel position
137 filtered measurements of PET
138 absorbance
144 classifying of out-of-line pixels
146 measuring a plurality of signals
148 comparing the measured signals and the reference spectrum
150 fringe pattern
152 signal intensity
154 noisy pixels
156 markers
158 analyzing the signal behavior around the pixel position
160 measurement step

1. A method for automated quality control of at least one photodetector comprising a plurality of pixels i, with i being a pixel position and i>2, wherein each pixel comprises at least one photosensitive region, wherein the pixels are arranged in at least one of an array or a matrix, wherein the pixel position is a position of the respective pixel in the array or matrix, wherein the photodetector is configured for detecting optical radiation from at least one object, wherein each of the pixels is configured for generating a signal in response to illumination by optical radiation of its respective photosensitive region, wherein the method comprises classifying of out-of-line pixels by
a) measuring a plurality of signals Sᵢ for the pixels by measuring at least one object using the photodetector; and
b) by using the processor, comparing the measured signals Sᵢ and at least one reference spectrum S_{F,i}, determining at least one quantifier Cᵢ for each pixel i quantifying a deviation between the respective measured signal Sᵢ and the reference spectrum S_{F,i}, and comparing the respective quantifier Cᵢ to at least one threshold Cₘₐₓ, wherein a pixel is classified as out-of-line pixel in case the respective quantifier Cᵢ exceeds the limit Cₘₐₓ, and
wherein the method further comprises analyzing the signal behavior around the pixel position i.

2. The method according to claim 1, wherein the method comprises determining a measured spectrum by using the signals Sᵢ of the pixels, wherein the reference spectrum S_{F,i} is determined by using the processor from the signals Sᵢ by applying at least one smoothing filter to the signals Sᵢ, and wherein the smoothing filter is at least one filter selected from the group consisting of a Savitzky-Golay filter, a polynomial of order n with n>4, moving average filter, local regression smoothing, low pass filtering, and other filters in pixel or Fourier space.

3. The method according to claim 1, wherein the quantifier is determined by
$${C}_{i} = \frac{{\vert {S}_{F , i} - {S}_{i} \vert}^{n}}{\sqrt[n]{{σ}_{F , i}^{n} + {σ}_{i}^{n}}} ,$$
with
$${σ}_{F , i}^{}$$
being the standard deviation of the reference spectrum and
$${σ}_{i}^{}$$
being the standard deviation of the measured signal of the pixel i.

4. The method according to claim 1, wherein in case of Cᵢ≥Cₘₐₓ, the pixel i is classified as out-of-line.

5. The method according to claim 1, wherein the method comprises searching for a pre-defined number of out-of-line pixels in a row, wherein a group of pixels at positions i+1, . . . i+N, with N being pre-defined number, is considered out-of-line if every separate criteria Cⱼ for an out-of-line pixel is fulfilled, combined into one C
$$C = {C}_{1} ∧ {C}_{2} ∧ … {C}_{N} .$$

6. The method according to claim 1, wherein the method comprises a linearity criterion, wherein the analyzing the signal behavior around the pixel position i comprises comparing a local derivative of the signal Sᵢ₊₁−Sᵢ to a derivative at the neighboring pixels, and/or wherein the method comprises a peak skip criterion, wherein the analyzing the signal behavior around the pixel position i comprises comparing the sign of a local derivative at pixel i to signs of derivatives of the neighboring pixels, and/or wherein the method comprises a slope ratio criterion, and wherein the analyzing the signal behavior around the pixel position i comprises comparing fluctuation in the derivatives around pixel i.

7. The method according to claim 1, wherein the method comprises masking all pixels which are classified as out-of-line, wherein the method comprises at least one measurement step, wherein the measurement step comprises determining at least one spectrum using the photodetector and wherein the masked pixels are ignored or mathematically corrected using neighboring pixels.

8. The method according to claim 1, wherein the method is computer-implemented.

9. The method according to claim 1, wherein the photodetector is a reflection spectrometer device or a transmission spectrometer device.

10. A method for automated quality control of at least one photodetector, wherein the photodetector comprises a plurality of pixels i, with i being a pixel position and i>2, wherein each pixel comprises at least one photosensitive region, wherein each of the pixels is configured for generating a signal in response to illumination by optical radiation of its respective photosensitive region, wherein the method comprises classifying of out-of-line pixels by analyzing a signal behavior around a pixel position i, and wherein the analyzing comprises testing one or more of the following criteria Cⱼ,
i) a linearity criterion, wherein a local derivative of a measured signal is compared to a derivative of neighboring pixels;
ii) a peak skip criterion, wherein a sign of a local derivative at pixel i is compared to signs of derivatives of the neighboring pixels; and
iii) a slope ratio criterion, wherein fluctuation in derivatives around pixel i are compared to each other.

11. A photodetector for measuring optical radiation, the photodetector being configured for performing the method according to claim 1, wherein the photodetector comprises a plurality of pixels i, with i being a pixel position and i>2, wherein each pixel comprises at least one photosensitive region, wherein each of the pixels is configured for generating a signal in response to illumination by optical radiation of its respective photosensitive region, and wherein the photodetector comprises at least one readout electronics unit.

12. A spectrometer for spectrally analyzing optical radiation provided by at least one object, the spectrometer comprising:
at least one radiation source configured for emitting optical radiation at least partially towards the object; and
at least one photodetector according to claim 11.

13. A computer program comprising instructions which, when the program is executed by a photodetector, cause the photodetector to perform the method according to claim 1.

14. A computer-readable storage medium comprising instructions which, when the instructions are executed by a photodetector, cause the photodetector to perform the method according to claim 1.

15. A method of using the spectrometer according to claim 12, the method comprising using the spectrometer for a purpose selected from the group consisting of an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; and a food analysis application.
